(19) United States
(12) Patent Application Publication
(10) Pub. No.: US 2026/0253361 A1
(43) Pub. Date: Aug. 27, 2026

(54) SYSTEM AND METHOD FOR VIDEO STREAMING USING DUAL UVC

(71) Applicant: E-CON SYSTEMS INDIA PRIVATE LIMITED., Chennai (IN)

(72) Inventors: S Jayashree, Chennai (IN); Manju Govindaradjou, Chennai (IN); Immanuvel Dass Leenus, Chennai (IN); P Esakki Raja, Chennai (IN)

(21) Appl. No.: 19/062,511

(22) Filed: Feb. 25, 2025

(51) Int. Cl. G06V 10/25; G06T 7/20

(52) U.S. Cl. CPC G06V 10/25; G06T 7/20

(57) ABSTRACT

The system and method for video streaming is disclosed. An image sensor configured to capture a first set of signals and a second set of signals. An Image Signal Processor (ISP) is configured to perform at least one image processing operation on the first set of signals and the second set of signals received from the image sensor to generate a first video stream from the first set of signals and a second video stream from the second set of signals. A USB controller configured to receive both the video stream from the ISP and enumerate the received video stream as if they were obtained from two independent image sensors. A host system communicatively coupled to the USB controller configured to identify the video stream that they are from two different image sensor and display video stream as two independent video streams.

### FIELD OF THE INVENTION

The present disclosure relates to video streaming. More particularly, it is related to a system and a method for independently streaming two distinct videos obtained from a single image sensor.

### BACKGROUND OF THE INVENTION

The following description of related art is intended to provide background information pertaining to the field of the present disclosure. This section may include certain aspects of the art that may be related to various aspects of the present disclosure. However, it should be appreciated that this section be used only to enhance the understanding of the reader with respect to the present disclosure, and therefore, unless otherwise indicated, it should not be assumed that any of the approaches described in this section qualify as prior art merely by virtue of their inclusion in this section.

During a live video streaming of an event using a motion detection camera, the camera typically captures both the full frame of the event and the motion-detected active region of interest (ROI). However, only the motion-detected active ROI is streamed to a user if motion is detected during the live broadcast. This means that either the full frame of the scene or the active ROI is streamed to the user, but not both simultaneously.

For instance, consider a virtual meeting room where a single camera captures a session. The camera is often configured to focus on a speaker of the session and provides a zoomed in view of the speaker which is streamed to the viewers over a communication network. While the speaker remains in focus, interactions with other participants in the room are not captured, leaving them out of view. This selective focus can create a sense of disconnection for the viewers, as the surrounding context of the session is excluded.

To address this problem in the conventional system, additional cameras may be adopted to address this limitation by focusing on different parts of the session. For instance, one camera might capture the entire session, and while the other camera focuses on the speaker who is currently interacting with the audience. However, this approach requires hiring an additional operator or a technician to monitor the session, switch between camera views, and ensure the broadcast remains engaging for viewers. Thus, the need for extra cameras and personnel significantly increases the cost of production.

Therefore, there is a need to find an alternative method to overcome the aforementioned problems.

### SUMMARY OF THE INVENTION

It is important to capture the entire region of the session without using additional cameras. It is also important to capture the entire region of the session simultaneously.

The present invention provides a significant advantage by utilizing a single camera to simultaneously stream two views: 1) a full Field of View (FOV); and 2) a zoomed-in Region of lnterest (ROI). These video streams are transmitted through a single USB interface using the dual USB Video Class (UVC) feature which enables the USB controller to enumerate the first video stream and second video stream from the single image sensor as two video streams obtained from two different image sensors over a single USB connection. The FOV and ROI streams are displayed together on a single output screen, enabling the user to view both full frame and speaker's zoomed ROI using the single camera hardware.

By offering both the FOV and ROI streams, this invention delivers a comprehensive viewing experience, combining a wide-angle perspective with a detailed, focused view of the scene. This approach eliminates the need for additional cameras and reduces associated labor. Furthermore, the present invention simplifies integration with existing video streaming systems and supports a wide range of applications.

According to a first aspect of the present disclosure, a video streaming system, comprising an image sensor configured to: capture a first set of signals representing a field of view (FOV) of the image sensor; and capture a second set of signals corresponding to one or more regions of in1terest (ROI) within the FOV. The image sensor captures the second set of signals only when a motion is detected in the FOV. An Image Signal Processor (ISP) communicatively coupled to the image sensor, the ISP is configured to perform at least one image processing operation on the first set of signals and the second set of signals received from the image sensor and to generate a first video stream from the first set of signals and a second video stream from the second set of signals. A Universal Serial Bus (USB) controller communicatively coupled to the ISP and the USB controller configured to receive the first video stream and the second video stream from the ISP. Further, the USB con1troller processes the received first video stream and the second video stream to generate corresponding USB Video Class (UVC) interface descriptors, wherein each UVC interface descriptor comprises a distinct video control descriptor and a video streaming descriptor and enumerates the received first video stream and the second video stream by associating each stream with an independent set of USB Video Class (UVC) interface descriptors, thereby enabling a host system to recognize and treat each video stream as originating. A host system communicatively coupled with the USB controller configured to identify that the first video stream and the second video stream are from two different image sensors and display the first video stream and the second video stream as two independent video streams.

In some aspects, the first set of signals and the second set of signals comprises a plurality of image frames. The ISP is configured to execute one or more image processing operations on the plurality of image frames, prior to the generation of the first video stream and the second video streams.

In some aspects, the USB controller comprises of a first virtual socket and a second virtual socket wherein the first virtual socket is configured to receive the first video stream, and the second virtual socket is configured to receive the second video stream from the ISP.

In some aspects, the USB controller uses the dual UVC feature for enumerating the first video stream and second video stream from the image sensor as the video streams obtained from separate two image sensors enabling the host system to access the video streams independently.

In some aspects, the image sensor is communicatively coupled to the ISP through an interface, the interface comprises a firs1t virtual channel and a second virtual channel. The image sensor transmits the first set of signals to the ISP through the first virtual channel and the second set of signals to the ISP through the second virtual channel.

In some aspects, the interface is :a mobile industry processor interface (MIPI) interface.

In some aspects, the host system further comprises an output unit communicatively coupled to the USB controller and configured to display the first video stream and the second video stream as independent video streams.

In some aspects, the image signal processor (ISP) is configured to: perform motion detection on the first set of signals, independently of the image sensor and generate a first video stream and a second video stream in which the motion detection is based on a zone-level analysis of the FOV.

According to a second aspect of the present disclosure, method for streaming a video comprises capturing, by way of an image sensor, at least one of, a first set of signals representing a field of view (FOV) of the image sensor and second set of signals corresponding to one or more regions of interest (ROI) within the FOV. The image sensor captures the second set of signals only when a motion is detected in the FOV. The method comprises, generating, by way of an Image Signal Processor (ISP) coupled to the image sensor, a first video stream from the first set of signals and the second video streams from the second set of signals. The method further comprises, receiving, by way of a USB controller communicatively coupled to the ISP, the first video stream and the second video stream and performs the following method steps. The USB controller after receiving the first video stream and the second video stream generates the USB Video Class (UVC) interface descriptors, wherein each UVC interface descriptor comprises a distinct video control descriptor and a video streaming descriptor. Further the USB controller enumerates the received first video stream and the second video stream as separate UVC devices by associating each stream with an independent set of endpoint descriptors, thereby enabling a host system to recognize and treat each video stream as originating from two independent image sensors ; and identifying, by a host system, the first video stream and the second video stream are from two different image sensors and displaying both the first video stream and the second video stream as a two independent video streams.

In some aspects, the method further comprises executing, by way of the ISP, one or more image processing operations on a plurality of image frames from the first set of signals and the second set of signals.

In some aspects, the method further comprises receiving, by way of first and second sockets of the USB controller, the first video stream through the first socket and the second video stream through the second socket.

In some aspects, the method further comprises transmitting, by way of an interface, the first set of signals and the set of signals to the ISP through a first virtual channel and a second virtual channel, respectively of the interface.

In some aspects, the method comprises receiving, by the ISP, a first set of signals associated with a field of view (FOV) of the image sensor and performing, by the ISP, motion detection on the first set of signals independently of the image sensor. The motion detection involves analysing zone-level changes in the FOV and identifying one or more regions of interest (ROIs). The method comprises generating a first video stream corresponding to the field of view and generating a second video stream corresponding to the one or more ROI identified through motion detection.

According to a third aspect of the present disclosure, a non-transitory storage medium comprising instructions that when executed by a processor and a controller of a video streaming system, causes the system to perform the above-mentioned method steps.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF ACCOMPANYING DRAWINGS

The above aspects, features and advantages of the disclosed technology, will be more fully appreciated by reference to the following illustrative and non-limiting detailed description of example embodiments of the present disclosure, when taken in conjunction with the accompanying drawings, in which:

FIG. 1 illustrates a block diagram of a video streaming system (100), according to an embodiment of the invention;

FIG. 2 illustrates a block diagram of a video streaming system (200), according to an embodiment of the invention;

FIG. 3 illustrates a flow chart of a method (300) for streaming the video, according to an embodiment of the invention;

FIG. 4 illustrates a flow chart of a method (400) for streaming the video, according to an embodiment of the invention;

FIG. 5 illustrates a flowchart of an exemplary method (500), according to an embodiment of the invention; and

FIG. 6 illustrates an exemplary working of the system (100 and 200) and method (300 and 400), according to some embodiments of the invention.

### DETAILED DESCRIPTION OF THE PREFERRED EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

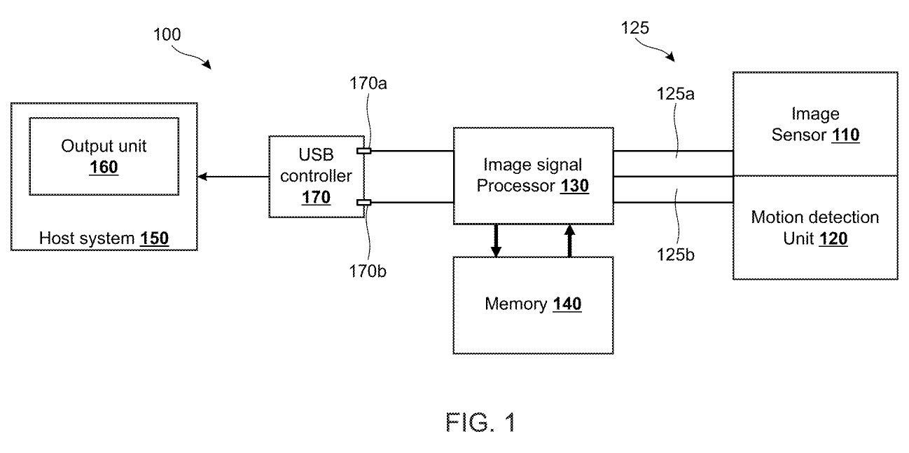

FIG. 1 illustrates a block diagram of a video streaming system (100) according to the main embodiment of the invention. As disclosed in FIG. 1, the system (100) comprises an image sensor (110), an Image Signal Processor (ISP) (130), a Universal Serial Bus (USB) controller (170) and a host system (150). The image sensor (110) is configured to capture a first set of signals representing a Field of View (FOV) of the image sensor (110), and a second set of signals corresponding to one or more Regions of Interest (ROI) within the FOV. The first and second sets of signals refer to either the raw or processed electronic/digital outputs generated by the image sensor (110). The first set of signals corresponds to a full frame of FOV, and the second set of signals corresponds to a frame specific to the identified ROI.

The image sensor (110) referred to herein is an imaging device capable of sensing and capturing visual data in the FOV/ROI in the form of one or more image frames for generating a comprehensive video stream of the FOV /ROI. The Field of View (FOV) in the context of video streaming refers to the entire observable area captured by the image sensor (110) within the single image frame. For example, FOV represents the entire area or region captured by the image sensor (110) in the field of view. On the other hand, the Regions of Interest (ROI) are a subset of the FOV and represent one or more specific regions of the FOV configured with particular significance.

As disclosed in FIG. 1, the image sensor (110) comprises a motion detection unit (120) configured to detect motion in the FOV as signals. The motion detection unit (120) is either built-in or integrated into an internal component of an imaging device. The image sensor (110) simultaneously captures the first set of signals and second set of signals when motion is detected in the FOV.

As disclosed in FIG. 1, the Image Signal Processor (ISP) (130) is communicatively coupled to the image sensor (110) through an interface (125). In some embodiments, the interface (125) comprises a first virtual channel (125a) and a second virtual channel (125b). The image sensor (110) transmits the first set of signals to the ISP (130) through the first virtual channel (125a) and the second set of signals to the ISP (130) through the second virtual channel (125b). The interface (125) is a mobile industry processor interface (MIPI) interface.

The Image Signal Processor (130) (also referred to as ISP (130)) is an image processor configured to perform at least one image processing operation on the plurality of image frames from the first set of signals and the second set of signals to generate a first video stream from the first set of signals and a second video stream corresponding to the one or more ROI from the second set of signals. The first video stream from the first set of signals refers to the video output representing the full frame of the entire scene observed within the FOV generated by the ISP (130). Likewise, the second video stream from the second set of signals refers to the video output representing the subset or specific region (identified as ROI) generated by the ISP (130).

For example, on receiving the first and second set of signals, the ISP (130) is configured to perform image processing operations such as enhancing image quality, debayering, applying color correction and automatic white balancing, frame stitching, region extraction, feature extraction, object detection, edge detection, and feature enhancement. After processing, the ISP (130) is configured to generate two distinct video streams.

In some embodiments, the first set of signals and the second set of signals include a plurality of image frames. Before generating the first video stream and the second video stream, the ISP (130) executes one or more image processing operations on a plurality of image frames to ensure that the streams meet the required quality and functionality. A memory (140) connected to the ISP (130) may also serve as a repository for storing data processed by the image sensor (110). The memory (140) may include data generated as a result of the execution of the image sensor (110). In an example, the memory (140) may include any computer-readable medium or computer program product known in the art including, for example, volatile memory, such as Static Random-Access Memory, SRAM, and Dynamic Random-Access Memory, DRAM, and/or non-volatile memory, such as Read Only Memory, ROM, Erasable Programmable ROM, EPROM, Electrically Erasable and Programmable ROM, EEPROM, flash memories, hard disks, optical disks, and magnetic tapes.

In some embodiments, the Universal Serial Bus (USB) controller (170) is communicatively coupled to the Image Signal Processor (130). The USB controller (170) comprises a first virtual socket (170a) and a second virtual socket (170b). The first virtual socket (170a) is configured to receive the first video stream, and the second virtual socket (170b) is configured to receive the second video stream from the ISP (130). The USB controller (170) is configured to process the first video stream and the second video stream as if they were obtained from two independent image sensors. For example, the USB controller (170) is configured to receive the FOV (i.e., first video stream) in the first virtual socket (170a) and receive the ROI (i.e., second video stream) in the second virtual socket (170b).

In some embodiments, the USB controller (170) uses dual USB Video Class (dual UVC) feature, which enables the USB controller (170) to enumerate the first and second video stream from the single image sensor (110) as two video streams obtained from separate two image sensors over a single USB connection enabling the host system (150) to access the video streams independently. Notably, the USB controller (170) advertises itself as two separate image sensors and the host system (150) identifies the first video stream and second video stream are from two different image sensors, despite being received from a single image sensor (110).

For instance, the USB controller enumerates itself as two independent USB Video Class (UVC) devices, despite receiving video input from a single image sensor (110). The USB controller (170) is configured to process the output i.e., the first video stream and second video stream from the ISP (130). The first video stream refers to the video output representing the full frame of the entire scene observed within the FOV. Likewise, the second video stream refers to the video output representing the subset or specific region (identified as ROI) generated by the ISP (130). The USB controller assigns UVC interfaces descriptors to these video streams, thereby enabling the host system (150) to recognize each stream as originating from an independent image sensor.

In an example, the USB controller (170) is configured to receive first set of signals representing a Field of View (FOV) of the image sensor (110), and a second set of signals corresponding to one or more Regions of Interest (ROI) within the FOV from the single image sensor (110) and generate two independent video streams by partitioning, encoding, or otherwise modifying the received image data. Each of the generated video streams are associated with a separate set of USB Video Control (VC) and Video Streaming (VS) descriptors. The USB controller is configured to associate each video stream with a unique endpoint descriptor, thereby enabling independent data transfer for each stream. By presenting two distinct UVC interfaces, the USB controller (170) ensures that the host system (150) enumerates and recognizes each stream as a separate video input device.

As shown in FIG. 1, the host system (150), which is communicatively coupled to the USB controller (170), identifies that the first video stream and the second video stream originate from two different image sensors. Further, the host system (150) comprises an output unit (160) and is configured to display the first video stream and the second video stream as two independent video streams. For example, the host system (150) may include various portable/non-portable computing devices such as a monitor, a laptop computer, a desktop computer, a notebook, a smart phone, a tablet, a phablet, or similar devices.

Upon enumeration, the host system (150) queries the USB controller (170) to retrieve UVC interface descriptors. The USB controller (170) responds with two distinct UVC interface descriptors, each corresponding to a separate video stream. Consequently, the host system (150) registers the USB controller (170) as two independent video devices, making the video streams accessible as separate sources in output unit (160). The host system (150) may further assign independent configuration parameters, such as resolution, frame rate, and encoding format, to each enumerated UVC device, thereby treating them as if they were derived from two physically separate image sensors.

In some examples, the ISP (130) may be configured to process multiple sets of signals from the image sensor (110) to generate multiple video streams, each corresponding to a specific ROI. The USB controller (170) is configured to receive multiple video streams from the ISP (130) and enumerates the multiple video streams as if they were obtained from multiple image sensors (110). Additionally, the host system (150) identifies the multiple video streams as originating from different image sensors and displays them on the output unit (160).

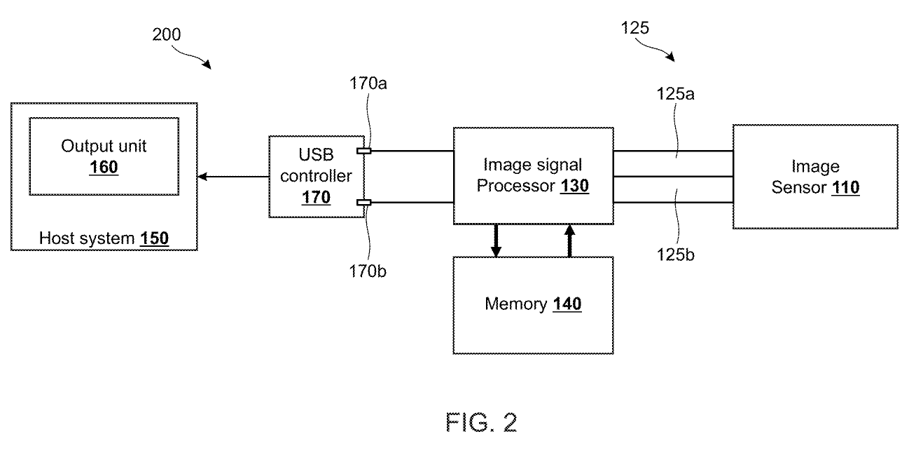

FIG. 2 discloses the video streaming system (200) in accordance with another embodiment of the present invention. In this embodiment, the ISP (130) is configured to perform motion detection on the first set of signals, independent of the image sensor (110) and generates a first video stream and a second video stream. The motion detection is based on a zone-level analysis of the FOV. It may be understood that all the other elements shown in FIG. 2 are configured to function as described in the preceding paragraphs.

In scenarios where the video streaming system (200) is equipped with the image sensor (110) but lacks a motion detection unit (120), the ISP (130) is configured to analyze only the first set of signals corresponding to the FOV and identify regions within the FOV where motion is detected by the ISP (130), without the need for additional motion detection hardware. These identified regions are then processed by the ISP (130) to generate a second set of signals which are different from the first set of signals. Subsequently, the ISP (130) is capable of producing a second video stream corresponding to the detected regions of motion.

In an example implementation of this embodiment, assuming an environment being monitored only by the image sensor (110) in the absence of a motion detection unit. The ISP (130) analyzes the visual data from the entire environment (which is taken as FOV) to detect specific regions where motion is present, such as the movement of a speaker illustrating a session. The ISP (130) is capable of detecting the regions with motion and generates a second set of signals which are subset and distinct from the entire FOV.

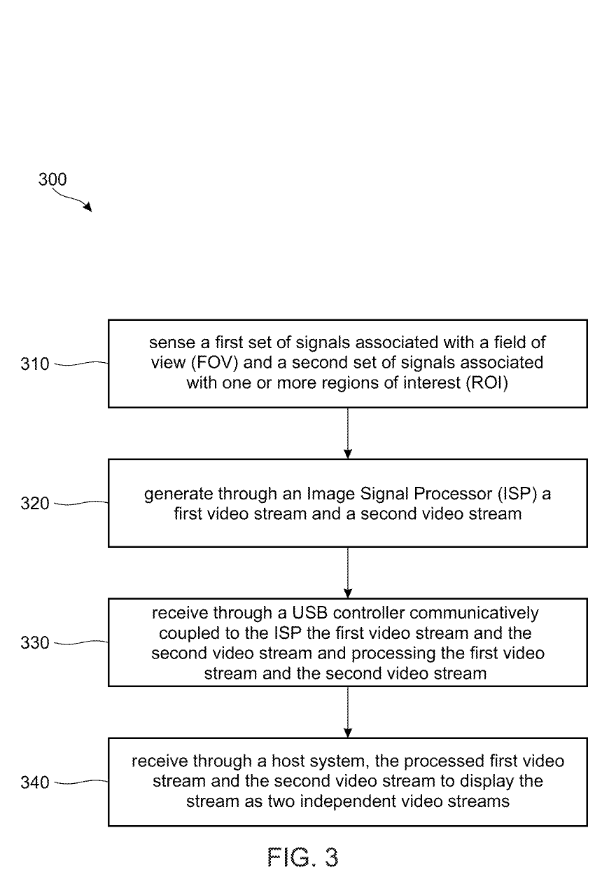

FIG. 3 illustrates a flow chart of a method (300) for streaming the video according to some embodiments of the present invention. At step (310), the method (300) comprises capturing, using an image sensor (110), at least one of a first set of signals representing a field of view (FOV) of the image sensor (110) and second set of signals corresponding to one or more regions of interest (ROI) in the FOV.

At step (320), the method (300) comprises generating using an Image Signal Processor (ISP) (130) coupled to the image sensor (110), a first video stream from the first set of signals and the second video streams from the second set of signals. The image sensor captures the second set of signals only when a motion is detected in the FOV.

At step (330), the method (300) comprises receiving, using a USB controller (170) communicatively coupled to the ISP (130), the first video stream and the second video stream and enumerates the received first video stream and the second video stream as if they were obtained from two independent image sensors.

For instance, the USB controller enumerates itself as two independent USB Video Class (UVC) devices, despite receiving video input from a single image sensor (110). The USB controller (170) is configured to process the output i.e., the first video stream and second video stream from the ISP (130). The first video stream refers to the video output representing the full frame of the entire scene observed within the FOV. Likewise, the second video stream refers to the video output representing the subset or specific region (identified as ROI) generated by the ISP (130). The USB controller assigns UVC interfaces descriptors to these video streams, thereby enabling the host system (150) to recognize each stream as originating from an independent image sensor.

In an example, the USB controller (170) is configured to receive first set of signals representing a Field of View (FOV) of the image sensor (110), and a second set of signals corresponding to one or more Regions of Interest (ROI) within the FOV from the single image sensor (110) and generate two independent video streams by partitioning, encoding, or otherwise modifying the received image data. Each of the generated video streams are associated with a separate set of USB Video Control (VC) and Video Streaming (VS) descriptors. The USB controller is configured to associate each video stream with a unique endpoint descriptor, thereby enabling independent data transfer for each stream. By presenting two distinct UVC interfaces, the USB controller (170) ensures that the host system (150) enumerates and recognizes each stream as a separate video input device.

At step (340), the method (300) comprises identifying, by the host system (150), that the first video stream and the second video stream are from two different image sensors and displaying both the first video stream and the second video stream as two independent video streams in the output unit (160).

For instance, upon enumeration, the host system (150) queries the USB controller (170) to retrieve UVC interface descriptors. The USB controller (170) responds with two distinct UVC interface descriptors, each corresponding to a separate video stream. Consequently, the host system (150) registers the USB controller (170) as two independent video devices, making the video streams accessible as separate sources in output unit (160). The host system (150) may further assign independent configuration parameters, such as resolution, frame rate, and encoding format, to each enumerated UVC device, thereby treating them as if they were derived from two physically separate image sensors.

In some embodiments, the method (300) further comprises executing, using the ISP (130), one or more image processing operations on a plurality of image frames of the first set of signals and the one or more second set of signals. The method (300) comprises receiving, by way of first and second sockets (170a and 170b) of the USB controller (170), the first video stream through the first socket (170a) and the second video stream through the second socket (170b). The method (300) further comprising transmitting, by way of an interface (125), the first set of signals and the second set of signals to the ISP (130) through a first virtual channel (125a) and second virtual channel (125b), respectively of the interface (125).

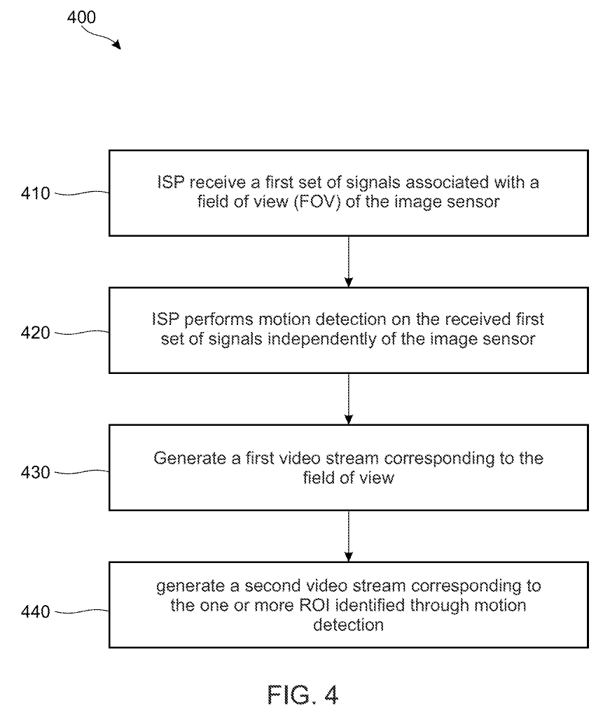

FIG. 4 illustrates a flow chart of a method (400) for streaming the video in accordance with some embodiment of the present invention. At step (410), the method (400) comprises receiving, by the ISP (130), a first set of signals associated with a field of view (FOV) of the image sensor (110).

At step (420), the method (400) comprises performing, by the ISP (130), a motion detection on the received first set of signals independently of the image sensor (110). The motion detection involves analysing zone-level changes in the FOV and identifying one or more regions of interest (ROIs).

At step (430), the method (400) comprises generating a first video stream corresponding to the field of view and at step (440), the method (400) comprises generating a second video stream corresponding to the one or more ROI identified through motion detection.

In another embodiment, a non-transitory storage medium comprising instructions stored thereon executable by a processor (130) and a controller of a video streaming system (100, 200) to perform a process comprising receiving, from an image sensor (110), at least one of, a first set of signals associated with a field of view FOV of the image sensor (110) and a second set of signals associated with one or more regions of interest ROI in the FOV. The non-transitory storage medium comprising, generating, by way of an Image Signal Processor (ISP) (130) communicatively coupled to the image sensor (110), a first video stream from the first set of signals and the second video stream corresponding to the one or more ROI from the second set of signals.

The non-transitory storage medium comprising, rece1vmg, by way of a USB controller (170) communicatively coupled to the ISP (130), the first video stream and the second video stream and enumerating the first video stream and the second video stream as if they were obtained from two independent image sensors (110). The non-transitory storage medium further comprises identifying, by the USB controller (170) communicatively coupled to a host system (150), that the first video stream and the second video stream are from two different image sensors and display the first video stream and the second video stream as two independent video streams.

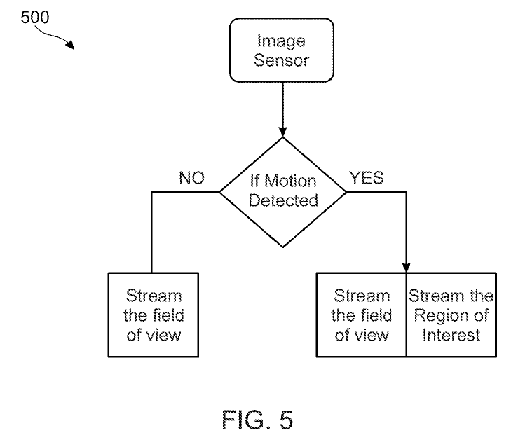

FIG. 5 illustrates a flowchart of an exemplary method (500), according to some embodiments of the invention. The ISP (130) of the system (100, 200) is configured to process and detect any motion in a plurality of images obtained from the image sensor (110). If no motion is detected, the ISP (130) is configured to stream the Field of View (FOV) to the host system (150). On the other hand, if motion is detected, the ISP (130) is configured to stream the Field of View (FOV) and the Region of Interest (ROI) in the host system (150).

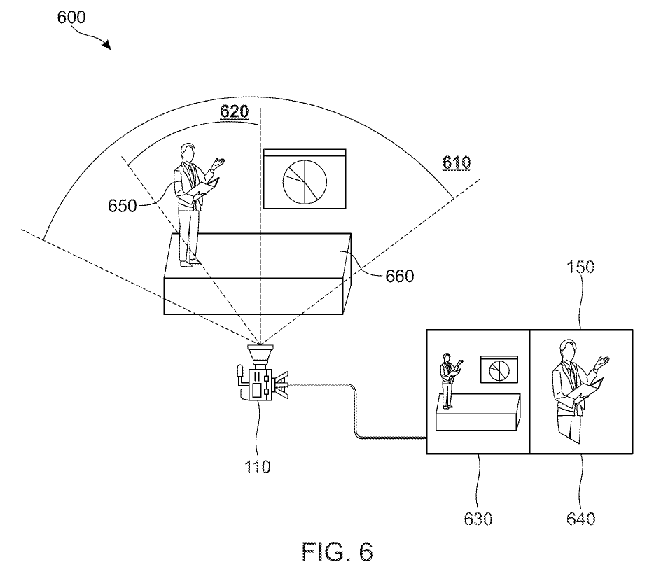

FIG. 6 illustrates an exemplary working embodiment (600) of the system (100 and 200) and method (300 and 400). FIG. 6 depicts a speaker (650) delivering a session on a platform (660) which is monitored by the image sensor (110). As described in the preceding paragraphs, the system (100 and 200) and method (300 and 400) are configured to detect and distinguish between a Field of View (FOV) (610) and a Region of Interest (ROI) (620) and generate a first video stream (630) and a second video stream (640). The first video stream (630) corresponds to the FOV (610), which captures the entire stage (660). The second video stream (640) corresponds to the ROI (620), which focuses on the motion induced by the speaker (650). Both video streams (630 and 640) are transmitted to the host system (150) where they are displayed independently as if they were obtained from two separate image sensors (110).

The present invention provides a technical advantage by enabling the display of both the full FOV and specific ROIs in a single output screen using a single image sensor. Furthermore, the present invention seamlessly integrates with existing video streaming systems and eliminates the need for an additional camera and reduces associated labor.

Although the present invention has been described in considerable detail with reference to certain preferred embodiments and examples thereof, other embodiments and equivalents are possible. Even though numerous characteristics and advantages of the present invention have been set forth in the foregoing description, together with functional and procedural details, the disclosure is illustrative only, and changes may be made in detail, especially in terms of the procedural steps within the principles of the invention to the full extent indicated by the broad general meaning of the terms. Thus, various modifications are possible of the presently disclosed system and process without deviating from the intended scope of the present invention.

What is claimed is:

1. A video streaming system, comprising:
an image sensor configured to:
capture a first set of signals representing a field of view (FOV) of the image sensor; and
capture a second set of signals corresponding to one or more regions of interest (ROI) within the FOV, wherein the image sensor captures the second set of signals only when a motion is de1tected in the FOV;
an Image Signal Processor (ISP) communicatively coupled to the image sensor, the ISP configured to:
perform at least one image processing operation on the first set of signals and the second set of signals received from the image sensor; and
generate a first video stream from the first set of signals and a second video stream from the second set of signals;
a Universal Serial Bus (USB) controller, communicatively coupled to the ISP, the USB controller configured to:
receive the first video stream and the second video stream from the ISP;
process the received first video stream and the second video stream to generate corresponding USB Video Class (UVC) interface descriptors, wherein each UVC interface descriptor comprises a distinct video control descriptor and a video streaming descriptor; and
enumerates the received first video stream and the second video stream by associating each stream with an independent set of endpoint descriptors, thereby enabling a host system to recognize and treat each video stream as originating from two independent image sensors; and
a host system communicatively coupled to the USB controller configured to:
identify that the first video stream and the second video stream are from two different image sensors; and
display the first video stream and the second video stream as two independent video streams.

2. The video streaming system of claim 1, wherein the first set of signals and the second set of signals comprises a plurality of image frames, wherein, the ISP is configured to execute one or more image processing operations on the plurality of image frames prior to generating the first video stream and the second video stream.

3. The video streaming system of claim 1, wherein the USB controller comprises of a first virtual socket and a second virtual socket wherein the first virtual socket is configured to receive the first video stream, and the second virtual socket is configured to receive the second video stream from the ISP.

4. The video streaming system of claim 1, wherein the USB controller uses the dual UVC feature for enumerating the first video stream and second video stream from the image sensor as the video streams obtained from separate two image sensors enabling the host system to access the video streams independently.

5. The video streaming system of claim 1, wherein the image sensor is communicatively coupled to the ISP through an interface, wherein the interface comprises a first virtual channel and a second virtual channel wherein the image sensor transmits the first set of signals to the ISP through the first virtual channel and the second set of signals to the ISP through the second virtual channel.

6. The video streaming system of claim 5, wherein the interface is a mobile industry processor interface (MIPI) interface.

7. The video streaming system of claim 1, wherein the host system further comprises an output unit communicatively coupled to the USB controller and configured to display the first video stream and the second video stream as independent video streams.

8. The video streaming system of claim 1, wherein the Image Signal Processor (ISP) is further configured to:
perform motion detection on the first set of signals, independently of the image sensor; and
generate a first video stream and a second video stream, wherein the motion detection is based on a zone-level analysis of the FOV.

9. A method for streaming a video, the method comprises:
capturing, by way of an image sensor, at least one of:
a first set of signals representing a field of view (FOV) of the image sensor; and
a second set of signals corresponding to one or more regions of interest (ROI) within the FOV, wherein the image sensor captures the second set of signals only when a motion is detected in the FOV;
performing, using an Image Signal Processor (ISP) communicatively coupled to the image sensor, at least one image processing operation on the first set of signals and the second set of signals received from the image sensor;
generating, using the Image Signal Processor (ISP), a first video stream from the first set of signals and a second video stream from the second set of signals;
receiving, using a Universal Serial Bus (USB) controller communicatively coupled to the ISP, the first video stream and the second video stream and performing the method steps of:
generating USB Video Class (UVC) interface descriptors, wherein each UVC interface descriptor comprises a distinct video control descriptor and a video streaming descriptor; and
enumerating the received first video stream and the second video stream as separate UVC devices by associating each stream with an independent set of endpoint descriptors, thereby enabling a host system to recognize and treat each video stream as originating from two independent image sensors; and
identifying, by a host system, that the first video stream and the second video stream are from two different image sensors and displaying both the first video stream and the second video stream as two independent video streams.

10. The method of claim 9, further comprising executing, using the ISP, one or more image processing operations on a plurality of image frames from the first set of signals and the second set of signals.

11. The method of claim 9, further comprising receiving, by way of first and second sockets of the USB controller, the first video stream through the first socket and the second video stream through the second socket.

12. The method of claim 9, further comprising transmitting, by way of an interface, the first set of signals and the set of signals to the ISP through a first virtual channel and a second virtual channel, respectively of the interface.

13. The method of claim 9, wherein the method comprises:
receiving, by the ISP, a first set of signals associated with a field of view (FOV) of the image sensor;
performing, by the ISP, motion detection on the received first set of signals independently of the image sensor, wherein the motion detection involves analysing zone-level changes in the FOV and identifying one or more regions of interest (ROIs);
generating a first video stream corresponding to the field of view; and
generating a second video stream corresponding to the one or more ROI identified through motion detection.

14. A non-transitory storage medium comprising instructions that, when executed by a processor and a controller of a video streaming system, cause the system to perform the method steps in claim 9.
